(19) United States
(12) Patent Application Publication
(10) Pub. No.: US 2018/0166186 A1
(43) Pub. Date: Jun. 14, 2018

(54) FLAME RETARDANT RESIN COMPOSITION, AND CABLE AND OPTICAL FIBER CABLE USING THE SAME

(71) Applicant: FUJIKURA LTD., Tokyo (JP)

(72) Inventors: Haruka Kohri, Chiba (JP); Shoichiro Nakamura, Chiba (JP); Tomohisa Watanabe, Chiba (JP)

(73) Assignee: FUJIKURA LTD., Tokyo (JP)

(21) Appl. No.: 15/580,297

(22) PCT Filed: Jun. 23, 2016
(86) PCT No.: PCT/JP2016/068610

§ 371 Date: Dec. 7, 2017

(30) Foreign Application Priority Data
Jun. 24, 2015 (JP) 2015-126276
Oct. 20, 2015 (JP) 2015-206745

(51) Int. Cl. H01B 7/295; H01B 3/44; G02B 6/44; C08K 3/26; C08K 5/098; C08K 5/3492; C08L 83/04

(52) U.S. Cl. CPC H01B 7/295; H01B 3/44; G02B 6/44; C08L 83/04; C08K 5/098; C08K 5/3492; C08K 3/26

(57) ABSTRACT

Disclosed is a flame retardant resin composition containing a polyolefin resin, a silicone compound, a fatty acid containing compound, calcium carbonate, and a triazine ring containing hindered amine compound. In this composition, relative to 100 parts by mass of the polyolefin resin, the silicone compound is blended at a ratio of 1.5 parts by mass or more and 10 parts by mass the fatty acid containing compound is blended at a ratio of 3 parts by mass or more and 20 parts by mass, the calcium carbonate is blended at a ratio of 10 parts by mass or more and less than 120 parts by mass, the triazine ring containing hindered amine compound is blended at a ratio of 0.05 part by mass or more and less than 10 parts by mass, and the triazine ring containing hindered amine compound includes an oxygen atom.

### TECHNICAL FIELD

One or more embodiments of the present invention relate to a flame retardant resin composition, and a cable and an optical fiber cable using the same.

### BACKGROUND

For a coating of a cable, an outer sheath of a cable, a tube, a tape, a wrapping material, a building material or the like, a so-called eco-material is widely used.

As the eco-material, known is a flame retardant resin composition in which a silicone compound such as silicone gum or the like and a fatty acid containing compound such as magnesium stearate or the like are added as a flame retardant aid to a polyolefin resin while calcium carbonate is also added as a flame retardant to the polyolefin resin (see Patent Document 1 described below).

### CITATION LIST

### Patent Document

Patent Document 1: JP 1997-169918 A

However, it is difficult to say that flame retardancy is sufficiently secured by the flame retardant resin composition described in the above Patent Document 1. Herein, if an addition amount of a flame retardant is increased, the flame retardancy can be improved. However, in this case, the mechanical characteristics of the flame retardant resin composition deteriorate.

For such reason, required is a flame retardant resin composition which can secure excellent mechanical characteristics as well as excellent flame retardancy.

### SUMMARY

One or more embodiments of the present invention provide a flame retardant resin composition which can secure excellent mechanical characteristics as well as excellent flame retardancy, and a cable and an optical fiber cable using the flame retardant resin composition.

It was found by the present inventors that the aforementioned characteristics of the resin composition may be obtained by blending, into a polyolefin resin, a triazine ring containing hindered amine compound which includes an oxygen atom, in addition to calcium carbonate, a silicone compound, and a fatty acid containing compound, each at a predetermined ratio.

Namely, one or more embodiments of the present invention relate to a flame retardant resin composition containing a polyolefin resin, a silicone compound, a fatty acid containing compound, calcium carbonate, and a triazine ring containing hindered amine compound, in which the silicone compound is blended at a ratio of 1.5 parts by mass or more and 10 parts by mass or less relative to 100 parts by mass of the polyolefin resin, the fatty acid containing compound is blended at a ratio of 3 parts by mass or more and 20 parts by mass or less relative to 100 parts by mass of the polyolefin resin, the calcium carbonate is blended at a ratio of 10 parts by mass or more and less than 120 parts by mass relative to 100 parts by mass of the polyolefin resin, the triazine ring containing hindered amine compound is blended at a ratio of 0.05 part by mass or more and less than 10 parts by mass relative to 100 parts by mass of the polyolefin resin, and the triazine ring containing hindered amine compound includes an oxygen atom.

According to the flame retardant resin composition of one or more embodiments of the present invention, excellent mechanical characteristics as well as excellent flame retardancy can be secured.

Furthermore, the present inventors surmises as follows for the reason why the above effect is obtained in the flame retardant resin composition of one or more embodiments of the present invention.

Namely, when calcium carbonate particles, a silicone compound, and a fatty acid containing compound are contained in the flame retardant resin composition, a barrier layer is formed on a surface of the polyolefin resin at the time of combustion of the flame retardant resin composition so that combustion of the polyolefin resin is suppressed. Meanwhile, when a triazine ring containing hindered amine compound including an oxygen atom is contained in the flame retardant resin composition, oxygen radicals are generated from the triazine ring containing hindered amine compound at the time of combustion of the flame retardant resin composition, and as those oxygen radicals capture hydrogen radicals that are generated due to decomposition of the polyolefin resin at the time of combustion, combustion of the polyolefin resin is suppressed. For that reason, it is considered that, due to a synergistic effect between the formation of the barrier layer at the time of combustion and the radical capturing effect, excellent flame retardancy can be obtained. It is also considered that, even with a small amount, the triazine ring containing hindered amine compound can effectively suppress combustion of the polyolefin resin due to the radical capturing effect. Accordingly, it becomes possible to reduce the blending amount of the triazine ring containing hindered amine compound relative to the polyolefin resin, and, as a result, it is considered that excellent mechanical characteristics can be secured.

In the flame retardant resin composition, it is preferable that the triazine ring containing hindered amine compound be blended at a ratio of 0.1 part by mass or more and less than 10 parts by mass relative to 100 parts by mass of the polyolefin resin.

In this case, more excellent flame retardancy is obtained in the flame retardant resin composition compared to a case in which the blending ratio of the triazine ring containing hindered amine compound is less than 0.1 part by mass relative to 100 parts by mass of the polyolefin resin.

In the flame retardant resin composition, it is preferable that the triazine ring containing hindered amine compound have a group represented by the following formula (1).

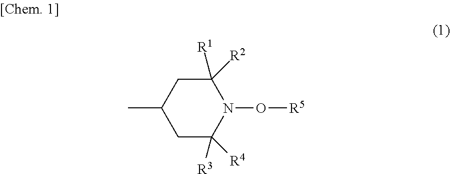

(in the above formula (1), R¹ to R⁴ are each independently an alkyl group having 1 to 8 carbon atoms, R⁵ is an alkyl group having 1 to 18 carbon atoms, a cycloalkyl group having 5 to 12 carbon atoms, an aralkyl group having 7 to 25 carbon atoms, or an aryl group having 6 to 12 carbon atoms).

In this case, more excellent flame retardancy is obtained from the flame retardant resin composition.

With regard to the flame retardant resin composition, it is preferable that, in the above formula (1), R¹ to R⁴ each independently represent an alkyl group having 1 to 3 carbon atoms and R⁵ represent a cycloalkyl group.

In this case, more excellent flame retardancy is obtained from the flame retardant resin composition.

With regard to the flame retardant resin composition, it is preferable that the triazine ring containing hindered amine compound be represented by the following formula (2).

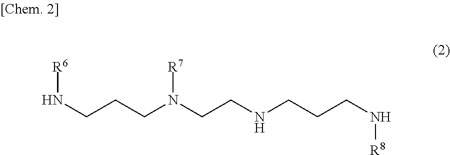

(in the above formula (2), R⁶ to R⁸ each independently represent a group represented by the following formula (3)).

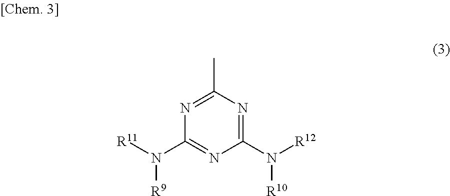

(in the above formula (3), R⁹ and R¹⁰ each independently represent a group represented by the above formula (1), and R¹¹ and R¹² each independently represent an alkyl group having 1 to 18 carbon atoms).

In the flame retardant resin composition, it is preferable that the triazine ring containing hindered amine compound be constituted by a compound which is represented by the above formula (2), and in which R¹ to R⁴ each independently represent an alkyl group having 1 to 3 carbon atoms and R⁵ represent a cycloalkyl group having 5 to 8 carbon atoms in the above formula (1), and R¹¹ and R¹² represent an alkyl group having 1 to 6 carbon atoms in the above formula (3).

In this case, more excellent flame retardancy is obtained in the flame retardant resin composition.

In the flame retardant resin composition, it is preferable that the silicone compound be blended at a ratio of 1.5 parts by mass or more and less than 5 parts by mass relative to 100 parts by mass of the polyolefin resin, the fatty acid containing compound be blended at a ratio of 3 parts by mass or more and less than 5 parts by mass relative to 100 parts by mass of the polyolefin resin, and the calcium carbonate be blended at a ratio of 10 parts by mass or more and 40 parts by mass or less relative to 100 parts by mass of the polyolefin resin.

In this case, more excellent mechanical characteristics can be obtained in the flame retardant resin composition.

In the flame retardant resin composition, it is preferable that the polyolefin resin be constituted by at least one kind selected from the group consisting of polyethylene, acid modified polyethylene, an ethylene-vinyl acetate copolymer, an ethylene-ethyl acrylate copolymer, and polypropylene.

In addition, one or more embodiments of the present invention are directed to a cable comprising a conductor and at least one insulating body for covering the conductor in which the insulating body is constituted by the aforementioned flame retardant resin composition.

Moreover, one or more embodiments of the present invention are directed to an optical fiber cable having an optical fiber and an insulating body covering the optical fiber in which the insulating body is constituted by the aforementioned flame retardant resin composition.

According to one or more embodiments of the present invention, a flame retardant resin composition which can secure excellent mechanical characteristics as well as excellent flame retardancy, and a cable and an optical fiber cable using the flame retardant resin composition are provided.

### BRIEF DESCRIPTION OF THE DRAWINGS

FIG. 1 is a partial side view illustrating a cable according to one or more embodiments of the present invention;

FIG. 2 is a cross-sectional view along the line II-II of FIG. 1 according to one or more embodiments of the present invention; and

FIG. 3 is a cross-sectional view illustrating an optical fiber cable according to one or more embodiments of the present invention.

### DETAILED DESCRIPTION OF THE EMBODIMENTS

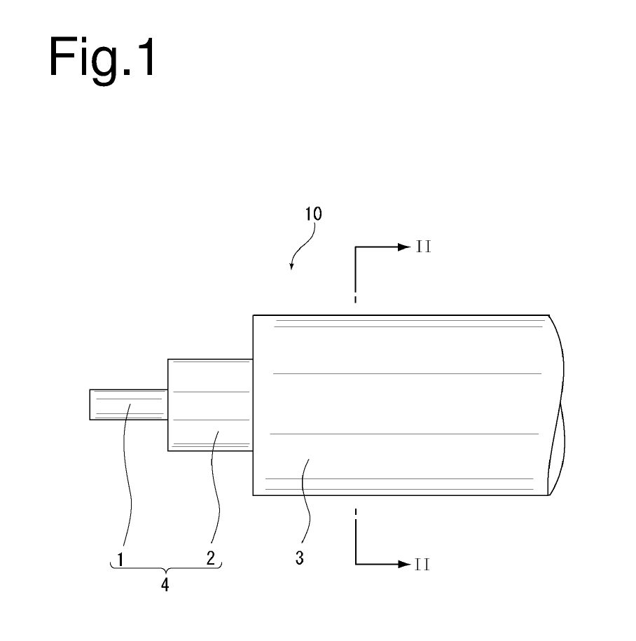

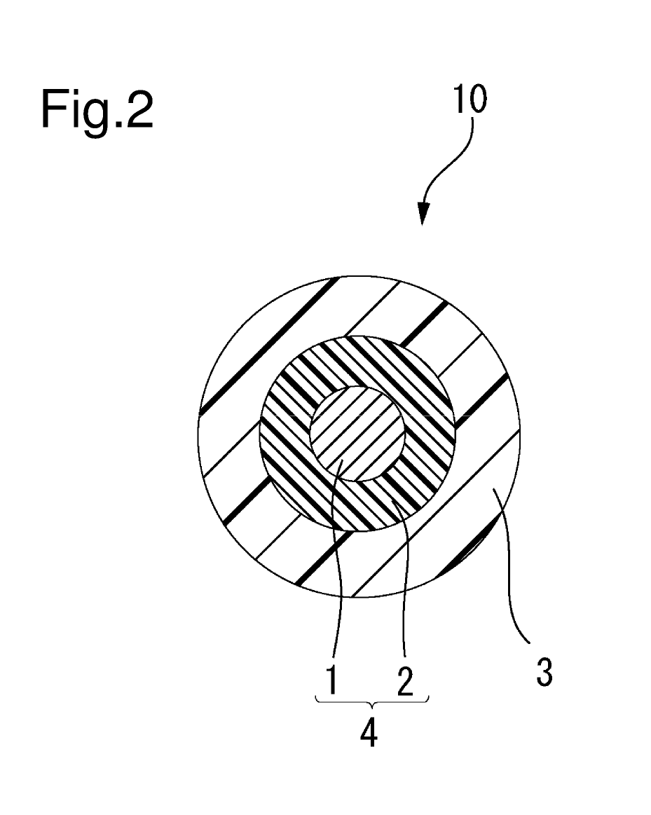

Hereinbelow, one or more embodiments of the present invention are explained in detail by using FIG. 1 and FIG. 2.

[Cable]

FIG. 1 is a partial side view illustrating a cable according to one or more embodiments of the present invention. FIG. 2 is a cross-sectional view along the line II-II of FIG. 1. As shown in FIG. 1 and FIG. 2, a round cable 10 comprises an insulating wire 4 and a tubular outer sheath 3 as an insulating body covering the insulating wire 4. Furthermore, the insulating wire 4 has an internal conductor 1 as a conductor and a tubular insulating body 2 covering the internal conductor 1. Namely, the round cable 10 is a metal cable, and in the round cable 10, the internal conductor 1 is provided on the inner side of the tubular insulating body 2 while it is simultaneously provided on the inner side of the tubular outer sheath 3.

Herein, the tubular insulating body 2 and the tubular outer sheath 3 consist of a flame retardant resin composition, which contains a polyolefin resin, a silicone compound, a fatty acid containing compound, calcium carbonate, and a triazine ring containing hindered amine compound, and the silicone compound is blended at a ratio of 1.5 parts by mass or more and 10 parts by mass or less relative to 100 parts by mass of the polyolefin resin, the fatty acid containing compound is blended at a ratio of 3 parts by mass or more and 20 parts by mass or less relative to 100 parts by mass of the polyolefin resin, the calcium carbonate is blended at a ratio of 10 parts by mass or more and less than 120 parts by mass relative to 100 parts by mass of the polyolefin resin, the triazine ring containing hindered amine compound is blended at a ratio of 0.05 part by mass or more and less than 10 parts by mass relative to 100 parts by mass of the polyolefin resin, and the triazine ring containing hindered amine compound includes an oxygen atom.

The insulating body 2 and the outer sheath 3 consisting of the above-mentioned flame retardant resin composition can secure excellent mechanical characteristics as well as excellent flame retardancy.

[Method for Producing a Cable]

Next, explanations are given for the method for producing the round cable 10 described above.

<Conductor>

First, the internal conductor 1 is prepared as a conductor. The internal conductor 1 may consist of only a single wire or consist of a bundle of plural single wires. Furthermore, the internal conductor 1 is not limited particularly in terms of conductor diameter or conductor material, and it can be suitably determined depending on use. As the internal conductor 1, metal such as copper or the like can be used.

<Flame Retardant Resin Composition>

Meanwhile, the flame retardant resin composition is prepared. As described above, the flame retardant resin composition contains the polyolefin resin, the silicone compound, the fatty acid containing compound, calcium carbonate, and the triazine ring containing hindered amine compound.

(1) Polyolefin Resin

Examples of the polyolefin resin include polyethylene (PE), acid modified polyethylene, ethylene-vinyl acetate copolymer (EVA), ethylene-ethyl acrylate copolymer (EEA), polypropylene (PP), ethylene-methyl acrylate copolymer (EMA), ethylene-propylene copolymer, ethylene-butene copolymer, ethylene-hexene copolymer, ethylene-octene copolymer, and an olefin-based thermoplastic elastomor. They can be used either singly or in combination of two or more types thereof. Among them, it is preferable that the polyolefin resin consist of at least one kind selected from the group consisting of polyethylene, acid modified polyethylene, an ethylene-vinyl acetate copolymer, an ethylene-ethyl acrylate copolymer, and polypropylene.

(2) Silicone Compound

The silicone compound functions as a flame retardant aid, and examples of the silicone compound include polyorganosiloxane. Herein, the polyorganosiloxane has a siloxane bond in the main chain and an organic group in the side chain. Examples of the organic group include an alkyl group such as a methyl group, an ethyl group, a propyl group, or a butyl group, a vinyl group, and an aryl group such as a phenyl group or a naphthyl group. Specific examples of the polyorganosiloxane include dimethyl polysiloxane, methylethyl polysiloxane, methyloctyl polysiloxane, methylvinyl polysiloxane, methylphenyl polysiloxane, and methyl(3,3,3-trifluoropropyl)polysiloxane. The polyorganosiloxane is used in the form of silicone oil, silicone powder, silicone gum, or silicone resin. In particular, the polyorganosiloxane is preferably used in the form of silicone gum. In this case, it is unlikely to have an occurrence of blooming.

As described in the above, the silicone compound is blended at a ratio of 1.5 parts by mass or more and 10 parts by mass or less relative to 100 parts by mass of the polyolefin resin. In this case, more excellent flame retardancy is obtained compared to a case in which the blending ratio of the silicone compound is less than 1.5 parts by mass. Furthermore, when the blending ratio of the silicone compound is within the above range relative to 100 parts by mass of the polyolefin resin, non-uniformity of the flame retardancy is lower compared to a case in which the blending ratio of the silicone compound is more than 10 parts by mass. That is because, as it becomes easier for the silicone compound to get uniformly blended in the polyolefin resin, a lump is unlikely to partially occur.

The blending ratio of the silicone compound relative to 100 parts by mass of the polyolefin resin is more preferably 8 parts by mass or less. The blending ratio of the silicone compound relative to 100 parts by mass of the polyolefin resin is particularly preferably 5 parts by mass or less. In this case, more excellent mechanical characteristics are obtained in the flame retardant resin composition compared to a case in which the blending ratio of the silicone compound is 5 parts by mass or more. Herein, the blending ratio of the silicone compound relative to 100 parts by mass of the polyolefin resin is more preferably 4 parts by mass or less. In this case, more excellent mechanical characteristics are obtained in the flame retardant resin composition compared to a case in which the blending ratio of the silicone compound is more than 4 parts by mass relative to 100 parts by mass of the polyolefin resin.

The silicone compound may be attached in advance on a surface of calcium carbonate. In this case, segregation of the silicone compound is unlikely to occur in the flame retardant resin composition, and thus uniformity of the characteristics of the flame retardant resin composition is further improved.

Examples of a method of obtaining the silicone compound attached to the surface of calcium carbonate may include a method in which the silicone compound is added to calcium carbonate to obtain a mixture, the mixture is dried for 10 to 40 minutes at 40 to 75° C., and the dried mixture is pulverized using a Henschel mixer, an atomizer, or the like, for example.

(3) Fatty Acid Containing Compound

The fatty acid containing compound functions as a flame retardant aid. The fatty acid containing compound indicates a compound containing a fatty acid or a metal salt thereof. Herein, as the fatty acid, a fatty acid having carbon atom number of 12 to 28 is used, for example. Examples of the fatty acid include lauric acid, myristic acid, palmitic acid, stearic acid, tuberculostearic acid, oleic acid, linoleic acid, arachidonic acid, behenic acid, and montanic acid. Among them, stearic acid or tuberculostearic acid is preferable as the fatty acid, and stearic acid is particularly preferable. In this case, more excellent flame retardancy is obtained in the flame retardant resin composition compared to a case in which a fatty acid other than tuberculostearic acid or stearic acid is used.

The fatty acid containing compound is preferably a fatty acid metal salt. Examples of the metal constituting the fatty acid metal salt include an alkali earth metal salt such as magnesium or calcium, zinc, and lead. As the fatty acid metal salt, magnesium stearate or calcium stearate is preferable. In this case, more excellent flame retardancy can be obtained with smaller addition amount in the flame retardant resin composition compared to a case in which a fatty acid metal salt other than magnesium stearate and calcium stearate is used.

As described above, the fatty acid containing compound is blended at a ratio of 3 parts by mass or more and 20 parts by mass or less relative to 100 parts by mass of the polyolefin resin. In this case, more excellent flame retardancy is obtained in the flame retardant resin composition compared to a case in which the blending ratio of the fatty acid containing compound is less than 3 parts by mass. Furthermore, when the blending ratio of the fatty acid containing compound is within the above range relative to 100 parts by mass of the polyolefin resin, bleeding is unlikely to occur compared to a case in which the blending ratio of the fatty acid containing compound is more than 20 parts by mass relative to 100 parts by mass of the polyolefin resin.

The blending ratio of the fatty acid containing compound relative to 100 parts by mass of the polyolefin resin is preferably 10 parts by mass or less, more preferably 8 parts by mass or less, and particularly preferably less than 5 parts by mass. In this case, when the blending ratio of the fatty acid containing compound is within the above range relative to 100 parts by mass of the polyolefin resin, more excellent mechanical characteristics are obtained in the flame retardant resin composition compared to a case in which the blending ratio is greater than the upper limit of each range described above.

The fatty acid containing compound can be attached in advance on a surface of calcium carbonate. In this case, segregation of the fatty acid containing compound is unlikely to occur in the flame retardant resin composition, and thus uniformity in the characteristics of the flame retardant resin composition is further improved. The fatty acid containing compound and the silicone compound can be attached in advance on a surface of calcium carbonate. In this case, segregation of the silicone compound and the fatty acid containing compound is unlikely to occur in the flame retardant resin composition, and thus uniformity of the characteristics in the flame retardant resin composition is further improved.

Examples of a method of obtaining the silicone compound and the fatty acid containing compound attached to the surface of calcium carbonate may include a method in which the silicone compound and the fatty acid containing compound are added to calcium carbonate to obtain a mixture, the mixture is dried for 10 to 40 minutes at 40 to 75° C., and the dried mixture is pulverized using a Henschel mixer, an atomizer, or the like, for example.

(4) Calcium Carbonate

Calcium carbonate can be any of heavy calcium carbonate and light calcium carbonate.

The average particle diameter of calcium carbonate is not particularly limited, but, preferably 1.2 to 1.8 μm. In this case, more excellent flame retardancy as well as excellent mechanical characteristics can be secured in the flame retardant resin composition.

The calcium carbonate is blended at a ratio of 10 parts by mass or more and less than 120 parts by mass relative to 100 parts by mass of the polyolefin resin. In this case, more excellent flame retardancy is obtained in the flame retardant resin composition compared to a case in which the ratio of calcium carbonate is less than 10 parts by mass relative to 100 parts by mass of the polyolefin resin.

Furthermore, as the blending ratio of calcium carbonate relative to 100 parts by mass of the polyolefin resin is within the above range, the mechanical characteristics of the flame retardant resin composition can be further improved compared to a case in which the blending ratio of calcium carbonate is 120 parts by mass or more relative to 100 parts by mass of the polyolefin resin.

The blending ratio of calcium carbonate relative to 100 parts by mass of the polyolefin resin is preferably 100 parts by mass or less, more preferably 80 parts by mass or less, and particularly preferably 60 parts by mass or less. In this case, the mechanical characteristics of the flame retardant resin composition can be more sufficiently improved compared to a case in which the blending ratio is out of each range described above.

In particular, the blending ratio of calcium carbonate relative to 100 parts by mass of the polyolefin resin is preferably 10 parts by mass or more and 80 parts by mass or less, and more preferably 10 parts by mass or more and 40 parts by mass or less. In a case in which the blending ratio of calcium carbonate relative to 100 parts by mass of the polyolefin resin is within the above range, the mechanical characteristics can be more sufficiently improved while more excellent flame retardancy of the flame retardant resin composition can be more sufficiently secured compared to a case in which the blending ratio is greater than the upper limit of each range described above. Herein, the blending ratio of calcium carbonate relative to 100 parts by mass of the polyolefin resin can also be 20 parts by mass or less.

Furthermore, in a case in which the silicone compound is blended at a ratio of 1.5 parts by mass or more and less than 5 parts by mass relative to 100 parts by mass of the polyolefin resin, it is preferable that the fatty acid containing compound be blended at a ratio of 3 parts by mass or more and less than 5 parts by mass relative to 100 parts by mass of the polyolefin resin and calcium carbonate be blended at a ratio of 10 parts by mass or more and 40 parts by mass or less relative to 100 parts by mass of the polyolefin resin.

In this case, more excellent mechanical characteristics can be obtained in the flame retardant resin composition.

(5) Triazine Ring Containing Hindered Amine Compound

The triazine ring containing hindered amine compound is not particularly limited as long as it includes an oxygen atom in the molecule. However, it is preferable that the triazine ring containing hindered amine compound be a compound which has a group represented by the following formula (1).

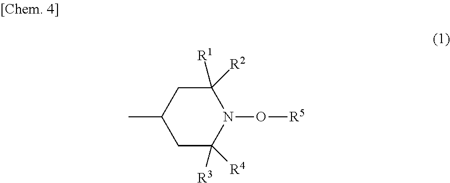

In the above formula (1), R¹ to R⁴ are each independently an alkyl group having 1 to 8 carbon atoms, R⁵ is an alkyl group having 1 to 18 carbon atoms, a cycloalkyl group having 5 to 12 carbon atoms, an aralkyl group having 7 to 25 carbon atoms, or an aryl group having 6 to 12 carbon atoms.

Examples of the alkyl group which is represented by R¹ to R⁴ in the above formula (1) include a methyl group, an ethyl group, a propyl group, a butyl group, a pentyl group, a hexyl group, a heptyl group, and an octyl group.

Herein, not only an unsubstituted alkyl group but also a substituted alkyl group is included in the “alkyl group”. As the substituted alkyl group, an alkyl group in which the hydrogen atom of an unsubstituted alkyl group is substituted with a halogen atom such as chlorine can be used.

Examples of the alkyl group which is represented by R⁵ in the above formula (1) include a methyl group, an ethyl group, a propyl group, a butyl group, a pentyl group, a hexyl group, a heptyl group, an octyl group, a nonyl group, a decyl group, a undecyl group, a dodecyl group, a tridecyl group, a tetradecyl group, a pentadecyl group, a hexadecyl group, a heptadecyl group, and an octadecyl group.

Examples of the cycloalkyl group which is represented by R⁵ include a cyclopentyl group, a cyclohexyl group, a cycloheptyl group, a cyclooctyl group, a cyclononyl group, a cyclodecyl group, a cycloundecyl group, and a cyclododecyl group.

Examples of the aralkyl group which is represented by R⁵ include a benzyl group (a phenylmethyl group), a phenylethyl group, a phenylpropyl group, a diphenylmethyl group, and a triphenylmethyl group.

Examples of the aryl group which is represented by R⁵ include a phenyl group and a naphthyl group.

In the above formula (1), it is preferable that R¹ to R⁴ each independently represent an alkyl group having 1 to 3 carbon atoms and R⁵ represent a cycloalkyl group having 5 to 8 carbon atoms.

In this case, more excellent flame retardancy can be obtained in the flame retardant resin composition.

Examples of the triazine ring containing hindered amine compound which has a group represented by the above formula (1) include a compound that is represented by the following formula (2).

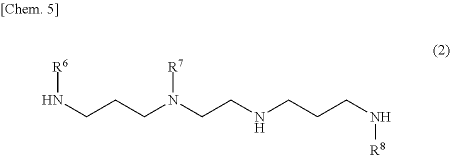

(in the above formula (2), R⁶ to R⁸ are each independently a group represented by the following formula (3)).

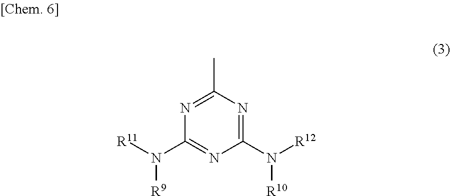

(in the above formula (3), R⁹ and R¹⁰ each independently represent a group represented by the above formula (1), and R¹¹ and R¹² each independently represent an alkyl group having 1 to 18 carbon atoms).

Examples of the alkyl group represented by R¹¹ and R¹² include an alkyl group which is the same as the alkyl group represented by R⁵ in the above formula (1).

As the triazine ring containing hindered amine compound, a compound which is represented by the above formula (2) and in which R¹ to R⁴ each independently represent an alkyl group having 1 to 3 carbon atoms and R⁵ represents a cycloalkyl group having 5 to 8 carbon atoms in the formula (1) and R¹¹ and R¹² represent an alkyl group having 1 to 6 carbon atoms in the formula (3) is preferable. In this case, more excellent flame retardancy is obtained in the flame retardant resin composition.

Specific examples of the triazine ring containing hindered amine compound include a compound which is represented by the above formula (2) and in which R¹ to R⁴ are a methyl group and R⁵ is a cyclohexyl group in the formula (1), R¹¹ and R¹² are a butyl group in the formula (3), R⁶ to R⁸ are mutually the same, and R⁹ and R¹⁰ are mutually the same (trade name: “FLAMESTAB NOR 116FF”, manufactured by BASF), a compound which has a group represented by the above formula (1) and a group represented by the above formula (3) (product name: “CYASORB UV-3529”, manufactured by Sun Chemical Company Ltd.), or the like.

The triazine ring containing hindered amine compound is blended at a ratio of 0.05 part by mass or more and less than 10 parts by mass relative to 100 parts by mass of the polyolefin resin.

In this case, more excellent flame retardancy can be obtained in the flame retardant resin composition compared to a case in which the blending ratio of the triazine ring containing hindered amine compound is less than 0.05 part by mass relative to 100 parts by mass of the polyolefin resin. Furthermore, when the blending ratio of the triazine ring containing hindered amine compound is within the above range relative to 100 parts by mass of the polyolefin resin, the mechanical characteristics and flame retardancy of the flame retardant resin composition can be further improved compared to a case in which the blending ratio of the triazine ring containing hindered amine compound is 10 parts by mass or more relative to 100 parts by mass of the polyolefin resin.

Furthermore, the blending ratio of the triazine ring containing hindered amine compound relative to 100 parts by mass of the polyolefin resin is preferably 0.1 part by mass or more. In this case, more excellent flame retardancy can be obtained in the flame retardant resin composition compared to a case in which the blending ratio of the triazine ring containing hindered amine compound is less than 0.1 part by mass relative to 100 parts by mass of the polyolefin resin.

Furthermore, the blending ratio of the triazine ring containing hindered amine compound relative to 100 parts by mass of the polyolefin resin is preferably 3 parts by mass or less, and more preferably 1 part by mass or less. In this case, it becomes possible that the flame retardant resin composition has excellent mechanical characteristics while securing the flame retardancy.

The flame retardant resin composition may include an anti-oxidant, a UV degradation preventing agent, a processing aid, a coloring pigment, a lubricating agent, and a filler such as carbon black or the like, if necessary.

The flame retardant resin composition can be obtained by kneading the polyolefin resin, the silicone compound, the fatty acid containing compound, the calcium carbonate, the triazine ring containing hindered amine compound and the like. Kneading can be carried out by using a kneading machine such as a Banbury mixer, a tumbler, a pressure kneader, a kneading and extruding machine, a biaxial extruding machine, a mixing roll, or the like. At this time, from the viewpoint of improving the dispersion property of the silicone compound, it is possible that part of the polyolefin resin is kneaded with the silicone compound, and then the obtained master batch (MB) is kneaded with the remaining polyolefin resin, the fatty acid containing compound, calcium carbonate, the triazine ring containing hindered amine compound and the like.

Next, the internal conductor 1 is covered with the flame retardant resin composition. Specifically, the flame retardant resin composition is melt-kneaded using an extruding machine to form a tubular extrudate. Then, the tubular extrudate is continuously coated onto the internal conductor 1. Thus, the insulating wire 4 is obtained.

<Outer Sheath>

Finally, one insulating wire 4 which has been obtained as described above is prepared, and this insulating wire 4 is covered with the outer sheath 3 which has been prepared using the flame retardant resin composition described above. The outer sheath 3 is a so-called sheath, and it protects the insulating body 2 from physical or chemical damages.

The round cable 10 is obtained as described above.

The present invention is not limited to the above embodiments. For example, although the round cable 10 having one insulating wire 4 is used as a cable in the above embodiment, the cable according to one or more embodiments of the present invention is not limited to a round cable, and it may be a cable which has two or more insulating wire 4 on the inner side of the outer sheath 3. A resin part consisting of polypropylene or the like may be provided between the outer sheath 3 and the insulating wire 4.

Furthermore, although the insulating body 2 and the outer sheath 3 of the insulating wire 4 is formed of the flame retardant resin composition in the above embodiment, the insulating body 2 may consist of a typical insulating resin and only the outer sheath 3 may consist of the flame retardant resin composition. Furthermore, the insulating body 2 is not necessarily required, and it can be omitted.

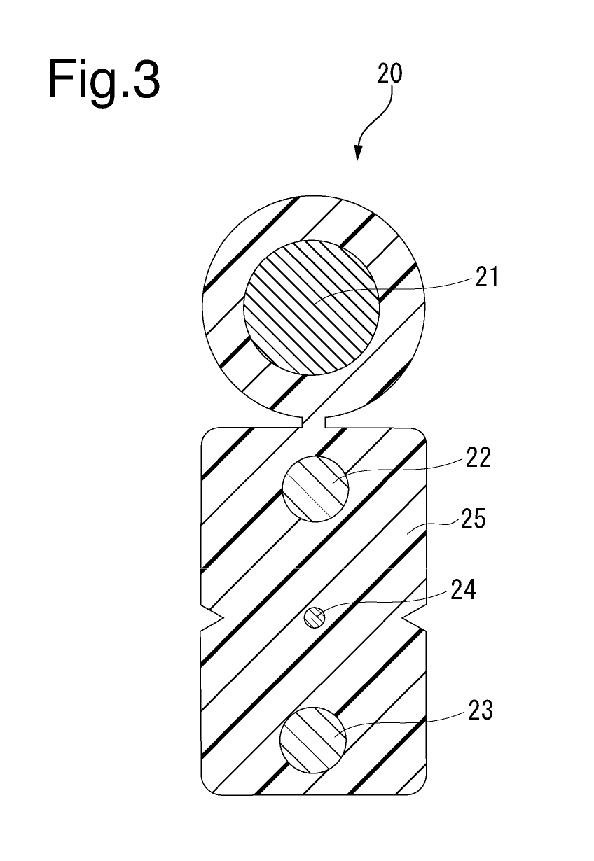

Furthermore, in the above embodiment, the flame retardant resin composition constituting the insulating body 2 and the outer sheath 3 of the insulating wire 4 can also be applied to an outer sheath covering an optical fiber of an optical fiber cable. For example, FIG. 3 is a cross-sectional view illustrating a drop type optical fiber cable as an example of the optical fiber cable. As shown in FIG. 3, an optical fiber cable 20 is provided with a supporting line 21, two tension members 22 and 23, an optical fiber 24, and an outer sheath 25 as an insulating body covering them. Herein, the outer sheath 25 is formed of the flame retardant resin composition which constitutes the insulating body 2 and the outer sheath 3 of the insulating wire 4.

Furthermore, the flame retardant resin composition of one or more embodiments of the present invention can be applied not only to the insulating body of the cable or the optical fiber cable described above but also to various uses such as a tube, a tape, wrapping material, and building material for which flame retardancy is required.

### EXAMPLES

Hereinbelow, the contents of one or more embodiments of the present invention is more specifically explained in view of Examples and Comparative Examples. However, the present invention is not limited to the following Examples.

### Examples 1 to 88 and Comparative Examples 1 to 54

A polyolefin resin, a silicone master batch (a silicone MB), a fatty acid containing compound, calcium carbonate, and a triazine ring containing hindered amine compound (HALS) were blended in the blending amount shown in Tables 1 to 25, and kneaded for 15 minutes at 160° C. by using a Banbury mixer and a flame retardant resin composition was obtained. Furthermore, in Tables 1 to 25, unit of the blending amount for each blending component is parts by mass. Furthermore, although there are some cases in Tables 1 to 25 in which the blending amount in the polyolefin resin part is not 100 parts by mass, the total blending amount becomes 100 parts by mass when the blending amount of the polyolefin resin and the blending amount of polyethylene (PE) included in the silicone MB are added.

As the above polyolefin resin, the silicone MB, the calcium carbonate, the fatty acid containing compound, and HALS, the followings were specifically used.

(1) Polyolefin Resin

### (1-1) Polyethylene (PE)

Trade name “EXCELLEN GMH GH030”, manufactured by Sumitomo Chemical Company Limited

(1-2) Acid modified polyethylene (acid modified PE)

Trade name “TAFMER MA8510”, manufactured by Mitsui Chemicals Inc.

### (1-3) Polypropylene (PP)

Trade name “J-452HP”, manufactured by Prime Polymer

(1-4) Ethylene ethylacrylate copolymer (EEA)

Trade name “REXPEARL A1150”, manufactured by Japan Polyethylene Corporation

### (1-5) Ethylene Vinyl Acetate Copolymer (EVA)

Trade name “EVAFLEX EV150”, manufactured by Mitsui DuPont Polychemicals Co., Ltd.

### (1-6) Styrene Ethylenebutadiene Styrene Copolymer (SEBS)

Trade name “TUFTEC M1913”, manufactured by Asahi Kasei Polychemicals

### (1-7) Styrene Butadiene Rubber (SBR)

Trade name “DYNARON 1320P”, manufactured by JSR Corporation

(2) Silicone MB

Trade name “X-22-2125H”, manufactured by Shin-Etsu Chemical Co., Ltd. (containing 50% by mass of silicone gum and 50% by mass of PE)

(3) Silicone Oil

Trade name “KF-96-350cs”, manufactured by Shin-Etsu Chemical Co., Ltd.

(4) Calcium Carbonate

Trade name “NCC-P”, manufactured by Nitto Funka Kogyo K.K., average particle diameter of 1.7 μm

(5) Fatty Acid Containing Compound

### (5-1) Mg Stearate

Trade name “AFCO CHEM MGS”, manufactured by ADEKA Corporation

### (5-2) Zn Stearate

Trade name “Zinc stearate G”, manufactured by NOF Corporation

(6) HALS

### (6-1) HALS1

A compound which is represented by the above formula (2) and in which R¹ to R⁴ are a methyl group and R⁵ is a cyclohexyl group in the formula (1), and, in the formula (3), R¹¹ and R¹² are a butyl group, R⁶ to R⁸ are mutually the same and R⁹ and R¹⁰ are mutually the same.

Trade name “FLAMESTAB NOR 116FF”, manufactured by BASF

### (6-2) HALS2

Trade name “CYASORB UV-3529”, manufactured by Sun Chemical Company Ltd.

Subsequently, the flame retardant resin composition was added to a monoaxial extruding machine (L/D=20, screw shape: full flight screw, manufactured by Marth Seiki Co., Ltd.). A tubular extrudate was extruded from the extruding machine and coated onto a conductor (number of single wire: 1 piece/unit area: 2 mm²) such that the thickness is 0.7 mm. Thus, an insulating wire was obtained.

TABLE 1

| | | | | Comparative | | | | | | | Comparative |
|---|---|---|---|---|---|---|---|---|---|---|---|
| | | | | Example 1 | Example 1 | Example 2 | Example 3 | Example 4 | Example 5 | Example 6 | Example 2 |
| Composition | Polyolefin | PE | | 97 | 97 | 97 | 97 | 97 | 97 | 97 | 97 |
| | resin | | | | | | | | | | |
| | Silicone MB | PE/Silicone | | 3/3 | 3/3 | 3/3 | 3/3 | 3/3 | 3/3 | 3/3 | 3/3 |
| | | gum | | | | | | | | | |
| | Fatty acid | Mg stearate | | 5 | 5 | 5 | 5 | 5 | 5 | 5 | 5 |
| | containing | | | | | | | | | | |
| | compound | | | | | | | | | | |
| | HALS | HALS1 | | | 0.05 | 0.1 | 0.5 | 1 | 3 | 5 | 10 |
| | Calcium carbonate | | | 40 | 40 | 40 | 40 | 40 | 40 | 40 | 40 |
| Characteristics | Mechanical | Tensile | | 15.7 | 15.8 | 15.7 | 15.6 | 15.2 | 15.4 | 15.0 | 14.2 |
| | characteristics | strength (MPa) | | | | | | | | | |
| | Flame | Vertical | Pass | 0 | 80 | 100 | 100 | 100 | 100 | 100 | 60 |
| | retardancy | flame | rate | | | | | | | | |
| | | test | (%) | | | | | | | | |

TABLE 2

| | | | | Comparative | Comparative | | | | Comparative |
|---|---|---|---|---|---|---|---|---|---|
| | | | | Example 3 | Example 4 | Example 7 | Example 3 | Example 8 | Example 5 |
| Composition | Polyolefin | PE | | 97 | 97 | 97 | 97 | 97 | 97 |
| | resin | | | | | | | | |
| | Silicone MB | PE/Silicone | | 3/3 | 3/3 | 3/3 | 3/3 | 3/3 | 3/3 |
| | | gum | | | | | | | |
| | Fatty acid | Mg stearate | | 5 | 5 | 5 | 5 | 5 | 5 |
| | containing | | | | | | | | |
| | compound | | | | | | | | |
| | HALS | HALS1 | | 0.5 | 0.5 | 0.5 | 0.5 | 0.5 | 0.5 |
| | Calcium carbonate | | | | 5 | 10 | 40 | 100 | 120 |
| Characteristics | Mechanical | Tensile | | 19.4 | 18.9 | 18.6 | 15.6 | 10.7 | 9.6 |
| | characteristics | strength (MPa) | | | | | | | |
| | Flame | Vertical | Pass | 0 | 40 | 100 | 100 | 100 | 100 |
| | retardancy | flame | rate | | | | | | |
| | | test | (%) | | | | | | |

TABLE 3

| | | | | Comparative | Comparative | | | Example | Example |
|---|---|---|---|---|---|---|---|---|---|
| | | | | Example 6 | Example 7 | Example 9 | Example 3 | 10 | 11 |
| Composition | Polyolefin resin | PE | | 97 | 97 | 97 | 97 | 97 | 97 |
| | Silicone MB | PE/Silicone gum | | 3/3 | 3/3 | 3/3 | 3/3 | 3/3 | 3/3 |
| | Fatty acid | Mg stearate | | | 2 | 3 | 5 | 10 | 20 |
| | containing | | | | | | | | |
| | compound | | | | | | | | |
| | HALS | HALS1 | | 0.5 | 0.5 | 0.5 | 0.5 | 0.5 | 0.5 |
| | Calcium carbonate | | | 40 | 40 | 40 | 40 | 40 | 40 |
| Characteristics | Mechanical | Tensile | | 16.6 | 16.1 | 16.0 | 15.6 | 15.1 | 14.4 |
| | characteristics | strength (MPa) | | | | | | | |
| | Flame retardancy | Vertical | Pass | 0 | 0 | 100 | 100 | 100 | 100 |
| | | flame | rate | | | | | | |
| | | test | (%) | | | | | | |

TABLE 4

| | | | | Comparative | Comparative | Example | | Example | Example |
|---|---|---|---|---|---|---|---|---|---|
| | | | | Example 8 | Example 9 | 12 | Example 3 | 13 | 14 |
| Composition | Polyolefin resin | PE | | 100 | 99.5 | 98.5 | 97 | 95 | 90 |
| | Silicone MB | PE/Silicone gum | | | 0.5/0.5 | 1.5/1.5 | 3/3 | 5/5 | 10/10 |
| | Fatty acid | Mg stearate | | 5 | 5 | 5 | 5 | 5 | 5 |
| | containing | | | | | | | | |
| | compound | | | | | | | | |
| | HALS | HALS1 | | 0.5 | 0.5 | 0.5 | 0.5 | 0.5 | 0.5 |
| | Calcium carbonate | | | 40 | 40 | 40 | 40 | 40 | 40 |
| Characteristics | Mechanical | Tensile | | 15.8 | 15.6 | 15.9 | 15.6 | 15.0 | 14.0 |
| | characteristics | strength (MPa) | | | | | | | |
| | Flame retardancy | Vertical | Pass | 0 | 0 | 100 | 100 | 100 | 100 |
| | | flame | rate | | | | | | |
| | | test | (%) | | | | | | |

TABLE 5

| | | | | Comparative | Example | Example | Example | Example | Example | Example | Comparative |
|---|---|---|---|---|---|---|---|---|---|---|---|
| | | | | Example 10 | 15 | 16 | 17 | 18 | 19 | 20 | Example 11 |
| Composition | Polyolefin | PE | | 87 | 87 | 87 | 87 | 87 | 87 | 87 | 87 |
| | resin | Acid modified | | 10 | 10 | 10 | 10 | 10 | 10 | 10 | 10 |
| | | PE | | | | | | | | | |
| | Silicone MB | PE/Silicone | | 3/3 | 3/3 | 3/3 | 3/3 | 3/3 | 3/3 | 3/3 | 3/3 |
| | | gum | | | | | | | | | |
| | Fatty acid | Mg stearate | | 5 | 5 | 5 | 5 | 5 | 5 | 5 | 5 |
| | containing | | | | | | | | | | |
| | compound | | | | | | | | | | |
| | HALS | HALS1 | | | 0.05 | 0.1 | 0.5 | 1 | 3 | 5 | 10 |
| | Calcium carbonate | | | 40 | 40 | 40 | 40 | 40 | 40 | 40 | 40 |
| Characteristics | Mechanical | Tensile | | 15.9 | 16.0 | 15.9 | 15.8 | 15.4 | 15.6 | 15.2 | 14.4 |
| | characteristics | strength (MPa) | | | | | | | | | |
| | Flame | Vertical | Pass | 0 | 80 | 100 | 100 | 100 | 100 | 100 | 60 |
| | retardancy | flame | rate | | | | | | | | |
| | | test | (%) | | | | | | | | |

TABLE 6

| | | | | Comparative | Comparative | Example | Example | Example | Comparative |
|---|---|---|---|---|---|---|---|---|---|
| | | | | Example 12 | Example 13 | 21 | 17 | 22 | Example 14 |
| Composition | Polyolefin | PE | | 87 | 87 | 87 | 87 | 87 | 87 |
| | resin | Acid modified | | 10 | 10 | 10 | 10 | 10 | 10 |
| | | PE | | | | | | | |
| | Silicone MB | PE/Silicone | | 3/3 | 3/3 | 3/3 | 3/3 | 3/3 | 3/3 |
| | | gum | | | | | | | |
| | Fatty acid | Mg stearate | | 5 | 5 | 5 | 5 | 5 | 5 |
| | containing | | | | | | | | |
| | compound | | | | | | | | |
| | HALS | HALS1 | | 0.5 | 0.5 | 0.5 | 0.5 | 0.5 | 0.5 |
| | Calcium carbonate | | | | 5 | 10 | 40 | 100 | 120 |
| Characteristics | Mechanical | Tensile | | 19.6 | 19.1 | 18.8 | 15.8 | 10.9 | 9.8 |
| | characteristics | strength (MPa) | | | | | | | |
| | Flame | Vertical | Pass | 0 | 40 | 100 | 100 | 100 | 100 |
| | retardancy | flame | rate | | | | | | |
| | | test | (%) | | | | | | |

TABLE 7

| | | | | Comparative | Comparative | Example | Example | Example | Example |
|---|---|---|---|---|---|---|---|---|---|
| | | | | Example 15 | Example 16 | 23 | 17 | 24 | 25 |
| Composition | Polyolefin resin | PE | | 87 | 87 | 87 | 87 | 87 | 87 |
| | | Acid modified | | 10 | 10 | 10 | 10 | 10 | 10 |
| | | PE | | | | | | | |
| | Silicone MB | PE/Silicone | | 3/3 | 3/3 | 3/3 | 3/3 | 3/3 | 3/3 |
| | | gum | | | | | | | |
| | Fatty acid | Mg stearate | | | 2 | 3 | 5 | 10 | 20 |
| | containing | | | | | | | | |
| | compound | | | | | | | | |
| | HALS | HALS1 | | 0.5 | 0.5 | 0.5 | 0.5 | 0.5 | 0.5 |
| | Calcium carbonate | | | 40 | 40 | 40 | 40 | 40 | 40 |
| Characteristics | Mechanical | Tensile | | 16.2 | 16.0 | 16.3 | 15.8 | 15.4 | 14.4 |
| | characteristics | strength (MPa) | | | | | | | |
| | Flame retardancy | Vertical | Pass | 0 | 0 | 100 | 100 | 100 | 100 |
| | | flame | rate | | | | | | |
| | | test | (%) | | | | | | |

TABLE 8

| | | | | Comparative | Comparative | Example | Example | Example | Example |
|---|---|---|---|---|---|---|---|---|---|
| | | | | Example 17 | Example 18 | 26 | 17 | 27 | 28 |
| Composition | Polyolefin resin | PE | | 90 | 89.5 | 88.5 | 87 | 85 | 80 |
| | | Acid modified | | 10 | 10 | 10 | 10 | 10 | 10 |
| | | PE | | | | | | | |
| | Silicone MB | PE/Silicone gum | | | 0.5/0.5 | 1.5/1.5 | 3/3 | 5/5 | 10/10 |
| | Fatty acid | Mg stearate | | 5 | 5 | 5 | 5 | 5 | 5 |
| | containing | | | | | | | | |
| | compound | | | | | | | | |
| | HALS | HALS1 | | 0.5 | 0.5 | 0.5 | 0.5 | 0.5 | 0.5 |
| | Calcium carbonate | | | 40 | 40 | 40 | 40 | 40 | 40 |
| Characteristics | Mechanical | Tensile | | 16 | 15.8 | 16.1 | 15.8 | 15.2 | 14.2 |
| | characteristics | strength (MPa) | | | | | | | |
| | Flame retardancy | Vertical | Pass | 0 | 0 | 100 | 100 | 100 | 100 |
| | | flame | rate | | | | | | |
| | | test | (%) | | | | | | |

TABLE 9

| | | | | Comparative | Example | Example | Example | Example | Example | Example | Comparative |
|---|---|---|---|---|---|---|---|---|---|---|---|
| | | | | Example 19 | 29 | 30 | 31 | 32 | 33 | 34 | Example 20 |
| Composition | Polyolefin | PP | | 97 | 97 | 97 | 97 | 97 | 97 | 97 | 97 |
| | resin | | | | | | | | | | |
| | Silicone MB | PE/Silicone | | 3/3 | 3/3 | 3/3 | 3/3 | 3/3 | 3/3 | 3/3 | 3/3 |
| | | gum | | | | | | | | | |
| | Fatty acid | Mg stearate | | 5 | 5 | 5 | 5 | 5 | 5 | 5 | 5 |
| | containing | | | | | | | | | | |
| | compound | | | | | | | | | | |
| | HALS | HALS1 | | | 0.05 | 0.1 | 0.5 | 1 | 3 | 5 | 10 |
| | Calcium carbonate | | | 40 | 40 | 40 | 40 | 40 | 40 | 40 | 40 |
| Characteristics | Mechanical | Tensile | | 20.5 | 20.6 | 20.5 | 20.4 | 20.0 | 20.2 | 19.8 | 19.0 |
| | characteristics | strength (MPa) | | | | | | | | | |
| | Flame | Vertical | Pass | 0 | 80 | 100 | 100 | 100 | 100 | 100 | 60 |
| | retardancy | flame | rate | | | | | | | | |
| | | test | (%) | | | | | | | | |

TABLE 10

| | | | | Comparative | Comparative | Example | Example | Example | Comparative |
|---|---|---|---|---|---|---|---|---|---|
| | | | | Example 21 | Example 22 | 35 | 31 | 36 | Example 23 |
| Composition | Polyolefin | PP | | 97 | 97 | 97 | 97 | 97 | 97 |
| | resin | | | | | | | | |
| | Silicone MB | PE/Silicone | | 3/3 | 3/3 | 3/3 | 3/3 | 3/3 | 3/3 |
| | | gum | | | | | | | |
| | Fatty acid | Mg stearate | | 5 | 5 | 5 | 5 | 5 | 5 |
| | containing | | | | | | | | |
| | compound | | | | | | | | |
| | HALS | HALS1 | | 0.5 | 0.5 | 0.5 | 0.5 | 0.5 | 0.5 |
| | Calcium carbonate | | | | 5 | 10 | 40 | 100 | 120 |
| Characteristics | Mechanical | Tensile | | 26 | 25.1 | 24.1 | 20.4 | 12.5 | 9.9 |
| | characteristics | strength (MPa) | | | | | | | |
| | Flame | Vertical | Pass | 0 | 40 | 100 | 100 | 100 | 100 |
| | retardancy | flame | rate | | | | | | |
| | | test | (%) | | | | | | |

TABLE 11

| | | | | Comparative | Comparative | Example | Example | Example | Example |
|---|---|---|---|---|---|---|---|---|---|
| | | | | Example 24 | Example 25 | 37 | 31 | 38 | 39 |
| Composition | Polyolefin resin | PP | | 97 | 97 | 97 | 97 | 97 | 97 |
| | Silicone MB | PE/Silicone gum | | 3/3 | 3/3 | 3/3 | 3/3 | 3/3 | 3/3 |
| | Fatty acid | Mg stearate | | | 2 | 3 | 5 | 10 | 20 |
| | containing | | | | | | | | |
| | compound | | | | | | | | |
| | HALS | HALS1 | | 0.5 | 0.5 | 0.5 | 0.5 | 0.5 | 0.5 |
| | Calcium carbonate | | | 40 | 40 | 40 | 40 | 40 | 40 |
| Characteristics | Mechanical | Tensile | | 21.4 | 20.9 | 20.8 | 20.4 | 19.9 | 19.2 |
| | characteristics | strength (MPa) | | | | | | | |
| | Flame retardancy | Vertical | Pass | 0 | 0 | 100 | 100 | 100 | 100 |
| | | flame | rate | | | | | | |
| | | test | (%) | | | | | | |

TABLE 12

| | | | | Comparative | Comparative | Example | Example | Example | Example |
|---|---|---|---|---|---|---|---|---|---|
| | | | | Example 26 | Example 27 | 40 | 31 | 41 | 42 |
| Composition | Polyolefin resin | PP | | 100 | 99.5 | 98.5 | 97 | 95 | 90 |
| | Silicone MB | PE/Silicone gum | | | 0.5/0.5 | 1.5/1.5 | 3/3 | 5/5 | 10/10 |
| | Fatty acid | Mg stearate | | 5 | 5 | 5 | 5 | 5 | 5 |
| | containing | | | | | | | | |
| | compound | | | | | | | | |
| | HALS | HALS1 | | 0.5 | 0.5 | 0.5 | 0.5 | 0.5 | 0.5 |
| | Calcium carbonate | | | 40 | 40 | 40 | 40 | 40 | 40 |
| Characteristics | Mechanical | Tensile | | 20.6 | 20.4 | 20.7 | 20.4 | 19.8 | 18.8 |
| | characteristics | strength (MPa) | | | | | | | |
| | Flame retardancy | Vertical | Pass | 0 | 0 | 100 | 100 | 100 | 100 |
| | | flame | rate | | | | | | |
| | | test | (%) | | | | | | |

TABLE 13

| | | | | Example | Example | Example | Example | Example | Example |
|---|---|---|---|---|---|---|---|---|---|
| | | | Example 3 | 31 | 17 | 43 | 44 | 45 | 46 |
| Composition | Polyolefin | PE | 97 | | 87 | 87 | 87 | | |
| | resin | PP | | 97 | | | | 87 | 87 |
| | | Acid modified PE | | | 10 | | | | |
| | | EEA | | | | 10 | | | |
| | | EVA | | | | | 10 | | |
| | | SEBS | | | | | | 10 | |
| | | SBR | | | | | | | 10 |
| | Silicone MB | PE/Silicone gum | 3/3 | 3/3 | 3/3 | 3/3 | 3/3 | 3/3 | 3/3 |
| | Fatty acid | Mg stearate | 5 | 5 | 5 | 5 | 5 | 5 | 5 |
| | containing | | | | | | | | |
| | compound | | | | | | | | |
| | HALS | HALS1 | 0.5 | 0.5 | 0.5 | 0.5 | 0.5 | 0.5 | 0.5 |

| | | | | | | | |
|---|---|---|---|---|---|---|---|
| Calcium carbonate | 40 | 40 | 40 | 40 | 40 | 40 | 40 |

| Characteristics | Mechanical | Tensile strength | | 15.6 | 20.4 | 15.8 | 13.5 | 12.5 | 23.5 | 25.6 |
|---|---|---|---|---|---|---|---|---|---|---|
| | characteristics | (MPa) | | | | | | | | |
| | Flame | Vertical | Pass | 100 | 100 | 100 | 100 | 100 | 100 | 100 |
| | retardancy | flame | rate | | | | | | | |
| | | test | (%) | | | | | | | |

TABLE 14

| | | | | Comparative | Example | Example | Example | Example | Example | Example | Comparative |
|---|---|---|---|---|---|---|---|---|---|---|---|
| | | | | Example 28 | 47 | 48 | 49 | 50 | 51 | 52 | Example 29 |
| Composition | Polyolefin | PE | | 100 | 100 | 100 | 100 | 100 | 100 | 100 | 100 |
| | resin | | | | | | | | | | |
| | Silicone MB | Silicone MB | | | | | | | | | |
| | | (PE/Silicone | | | | | | | | | |
| | | gum) | | | | | | | | | |
| | Silicone oil | | | 3 | 3 | 3 | 3 | 3 | 3 | 3 | 3 |
| | Fatty acid | Mg stearate | | 5 | 5 | 5 | 5 | 5 | 5 | 5 | 5 |
| | containing | | | | | | | | | | |
| | compound | | | | | | | | | | |
| | HALS | HALS1 | | | 0.05 | 0.1 | 0.5 | 1 | 3 | 5 | 10 |
| | Calcium carbonate | | | 40 | 40 | 40 | 40 | 40 | 40 | 40 | 40 |
| Characteristics | Mechanical | Tensile | | 15.2 | 15.3 | 15.2 | 15.1 | 14.7 | 14.9 | 14.5 | 13.7 |
| | characteristics | strength (MPa) | | | | | | | | | |
| | Flame | Vertical | Pass | 0 | 80 | 100 | 100 | 100 | 100 | 100 | 60 |
| | retardancy | flame | rate | | | | | | | | |
| | | test | (%) | | | | | | | | |

TABLE 15

| | | | | Comparative | Comparative | Example | Example | Example | Comparative |
|---|---|---|---|---|---|---|---|---|---|
| | | | | Example 30 | Example 31 | 53 | 49 | 54 | Example 32 |
| Composition | Polyolefin | PE | | 100 | 100 | 100 | 100 | 100 | 100 |
| | resin | | | | | | | | |
| | Silicone MB | Silicone MB | | | | | | | |
| | | (PE/Silicone | | | | | | | |
| | | gum) | | | | | | | |
| | Silicone oil | | | 3 | 3 | 3 | 3 | 3 | 3 |
| | Fatty acid | Mg stearate | | 5 | 5 | 5 | 5 | 5 | 5 |
| | containing | | | | | | | | |
| | compound | | | | | | | | |
| | HALS | HALS1 | | 0.5 | 0.5 | 0.5 | 0.5 | 0.5 | 0.5 |
| | Calcium carbonate | | | | 5 | 10 | 40 | 100 | 120 |
| Characteristics | Mechanical | Tensile | | 18.9 | 18.4 | 18.1 | 15.1 | 10.2 | 9.1 |
| | characteristics | strength (MPa) | | | | | | | |
| | Flame | Vertical | Pass | 0 | 40 | 100 | 100 | 100 | 100 |
| | retardancy | flame | rate | | | | | | |
| | | test | (%) | | | | | | |

TABLE 16

| | | | | Comparative | Comparative | Example | Example | Example | Example |
|---|---|---|---|---|---|---|---|---|---|
| | | | | Example 33 | Example 34 | 55 | 49 | 56 | 57 |
| Composition | Polyolefin resin | PE | | 100 | 100 | 100 | 100 | 100 | 100 |
| | Silicone MB | Silicone MB | | | | | | | |
| | | (PE/Silicone | | | | | | | |
| | | gum) | | | | | | | |
| | Silicone oil | | | 3 | 3 | 3 | 3 | 3 | 3 |
| | Fatty acid | Mg stearate | | | 2 | 3 | 5 | 10 | 20 |
| | containing | | | | | | | | |
| | compound | | | | | | | | |
| | HALS | HALS1 | | 0.5 | 0.5 | 0.5 | 0.5 | 0.5 | 0.5 |
| | Calcium carbonate | | | 40 | 40 | 40 | 40 | 40 | 40 |
| Characteristics | Mechanical | Tensile strength | | 16.1 | 15.6 | 15.5 | 15.1 | 14.6 | 13.9 |
| | characteristics | (MPa) | | | | | | | |
| | Flame retardancy | Vertical | Pass | 0 | 0 | 100 | 100 | 100 | 100 |
| | | flame | rate | | | | | | |
| | | test | (%) | | | | | | |

TABLE 17

| | | | | Comparative | Comparative | Example | Example | Example | Example |
|---|---|---|---|---|---|---|---|---|---|
| | | | | Example 35 | Example 36 | 58 | 49 | 59 | 60 |
| Composition | Polyolefin resin | PE | | 100 | 100 | 100 | 100 | 100 | 100 |
| | Silicone MB | Silicone MB | | | | | | | |
| | | (PE/Silicone | | | | | | | |
| | | gum) | | | | | | | |
| | Silicone oil | | | | 0.5 | 1.5 | 3 | 5 | 10 |
| | Fatty acid | Mg stearate | | 5 | 5 | 5 | 5 | 5 | 5 |
| | containing | | | | | | | | |
| | compound | | | | | | | | |
| | HALS | HALS1 | | 0.5 | 0.5 | 0.5 | 0.5 | 0.5 | 0.5 |
| | Calcium carbonate | | | 40 | 40 | 40 | 40 | 40 | 40 |
| Characteristics | Mechanical | Tensile strength | | 15.3 | 15.1 | 15.4 | 15.1 | 14.5 | 13.5 |
| | characteristics | (MPa) | | | | | | | |
| | Flame retardancy | Vertical | Pass | 0 | 0 | 100 | 100 | 100 | 100 |
| | | flame | rate | | | | | | |
| | | test | (%) | | | | | | |

TABLE 18

| | | | | Comparative | Example | Example | Example | Example | Example | Example | Comparative |
|---|---|---|---|---|---|---|---|---|---|---|---|
| | | | | Example 37 | 61 | 62 | 63 | 64 | 65 | 66 | Example 38 |
| Composition | Polyolefin resin | PE | | 97 | 97 | 97 | 97 | 97 | 97 | 97 | 97 |
| | Silicone MB | Silicone MB | | 3/3 | 3/3 | 3/3 | 3/3 | 3/3 | 3/3 | 3/3 | 3/3 |
| | | (PE/Silicone | | | | | | | | | |
| | | gum) | | | | | | | | | |
| | Fatty acid | Mg stearate | | | | | | | | | |
| | containing | Zn stearate | | 5 | 5 | 5 | 5 | 5 | 5 | 5 | 5 |
| | compound | | | | | | | | | | |
| | HALS | HALS1 | | | 0.05 | 0.1 | 0.5 | 1 | 3 | 5 | 10 |
| | Calcium carbonate | | | 40 | 40 | 40 | 40 | 40 | 40 | 40 | 40 |
| Characteristics | Mechanical | Tensile | | 15.6 | 15.7 | 15.6 | 15.5 | 15.1 | 15.3 | 14.9 | 14.1 |
| | characteristics | strength (MPa) | | | | | | | | | |
| | Flame | Vertical | Pass | 0 | 80 | 100 | 100 | 100 | 100 | 100 | 60 |
| | retardancy | flame | rate | | | | | | | | |
| | | test | (%) | | | | | | | | |

TABLE 19

| | | | | Comparative | Comparative | Example | Example | Example | Comparative |
|---|---|---|---|---|---|---|---|---|---|
| | | | | Example 39 | Example 40 | 67 | 63 | 68 | Example 41 |
| Composition | Polyolefin resin | PE | | 97 | 97 | 97 | 97 | 97 | 97 |
| | Silicone MB | Silicone MB | | 3/3 | 3/3 | 3/3 | 3/3 | 3/3 | 3/3 |
| | | (PE/Silicone | | | | | | | |
| | | gum) | | | | | | | |
| | Fatty acid | Mg stearate | | | | | | | |
| | containing | Zn stearate | | 5 | 5 | 5 | 5 | 5 | 5 |
| | compound | | | | | | | | |
| | HALS | HALS1 | | 0.5 | 0.5 | 0.5 | 0.5 | 0.5 | 0.5 |
| | Calcium carbonate | | | | 5 | 10 | 40 | 100 | 120 |
| Characteristics | Mechanical | Tensile | | 19.3 | 18.8 | 18.5 | 15.5 | 10.6 | 9.5 |
| | characteristics | strength | | | | | | | |
| | | (MPa) | | | | | | | |
| | Flame retardancy | Vertical | Pass | 0 | 40 | 100 | 100 | 100 | 100 |
| | | flame | rate | | | | | | |
| | | test | (%) | | | | | | |

TABLE 20

| | | | | Comparative | Comparative | Example | Example | Example | Example |
|---|---|---|---|---|---|---|---|---|---|
| | | | | Example 42 | Example 43 | 69 | 63 | 70 | 71 |
| Composition | Polyolefin resin | PE | | 97 | 97 | 97 | 97 | 97 | 97 |
| | Silicone MB | Silicone MB | | 3/3 | 3/3 | 3/3 | 3/3 | 3/3 | 3/3 |
| | | (PE/Silicone | | | | | | | |
| | | gum) | | | | | | | |
| | Fatty acid | Mg stearate | | | | | | | |
| | containing compound | Zn stearate | | | 2 | 3 | 5 | 10 | 20 |
| | HALS | HALS1 | | 0.5 | 0.5 | 0.5 | 0.5 | 0.5 | 0.5 |
| | Calcium carbonate | | | 40 | 40 | 40 | 40 | 40 | 40 |
| Characteristics | Mechanical | Tensile | | 16.5 | 16.0 | 15.9 | 15.5 | 15.0 | 14.3 |
| | characteristics | strength (MPa) | | | | | | | |
| | Flame retardancy | Vertical | Pass | 0 | 0 | 100 | 100 | 100 | 100 |
| | | flame | rate | | | | | | |
| | | test | (%) | | | | | | |

TABLE 21

| | | | | Comparative | Comparative | Example | Example | Example | Example |
|---|---|---|---|---|---|---|---|---|---|
| | | | | Example 44 | Example 45 | 72 | 63 | 73 | 74 |
| Composition | Polyolefin resin | PE | | 100 | 99.5 | 98.5 | 97 | 95 | 90 |
| | Silicone MB | Silicone MB | | | 0.5/0.5 | 1.5/1.5 | 3/3 | 5/5 | 10/10 |
| | | (PE/Silicone | | | | | | | |
| | | gum) | | | | | | | |
| | Fatty acid | Mg stearate | | | | | | | |
| | containing compound | Zn stearate | | 5 | 5 | 5 | 5 | 5 | 5 |
| | HALS | HALS1 | | 0.5 | 0.5 | 0.5 | 0.5 | 0.5 | 0.5 |
| | Calcium carbonate | | | 40 | 40 | 40 | 40 | 40 | 40 |
| Characteristics | Mechanical | Tensile | | 15.7 | 15.5 | 15.8 | 15.5 | 14.9 | 13.9 |
| | characteristics | strength (MPa) | | | | | | | |
| | Flame retardancy | Vertical | Pass | 0 | 0 | 100 | 100 | 100 | 100 |
| | | flame | rate | | | | | | |
| | | test | (%) | | | | | | |

TABLE 22

| | | | | Comparative | Example | Example | Example | Example | Example | Example | Comparative |
|---|---|---|---|---|---|---|---|---|---|---|---|
| | | | | Example 46 | 75 | 76 | 77 | 78 | 79 | 80 | Example 47 |
| Composition | Polyolefin | PE | | 97 | 97 | 97 | 97 | 97 | 97 | 97 | 97 |
| | resin | | | | | | | | | | |
| | Silicone MB | Silicone MB | | 3/3 | 3/3 | 3/3 | 3/3 | 3/3 | 3/3 | 3/3 | 3/3 |
| | | (PE/Silicone | | | | | | | | | |
| | | gum) | | | | | | | | | |
| | Fatty acid | Mg stearate | | 5 | 5 | 5 | 5 | 5 | 5 | 5 | 5 |
| | containing | | | | | | | | | | |
| | compound | | | | | | | | | | |
| | HALS | HALS1 | | | | | | | | | |
| | | HALS2 | | | 0.05 | 0.1 | 0.5 | 1 | 3 | 5 | 10 |
| | Calcium carbonate | | | 40 | 40 | 40 | 40 | 40 | 40 | 40 | 40 |
| Characteristics | Mechanical | Tensile | | 15.7 | 15.8 | 15.7 | 15.6 | 15.2 | 15.4 | 15.0 | 14.2 |
| | characteristics | strength (MPa) | | | | | | | | | |
| | Flame | Vertical | Pass | 0 | 80 | 100 | 100 | 100 | 100 | 100 | 60 |
| | retardancy | flame | rate | | | | | | | | |
| | | test | (%) | | | | | | | | |

TABLE 23

| | | | | Comparative | Comparative | Example | Example | Example | Comparative |
|---|---|---|---|---|---|---|---|---|---|
| | | | | Example 48 | Example 49 | 81 | 77 | 82 | Example 50 |
| Composition | Polyolefin | PE | | 97 | 97 | 97 | 97 | 97 | 97 |
| | resin | | | | | | | | |
| | Silicone MB | Silicone MB | | 3/3 | 3/3 | 3/3 | 3/3 | 3/3 | 3/3 |
| | | (PE/Silicone | | | | | | | |
| | | gum) | | | | | | | |
| | Fatty acid | Mg stearate | | 5 | 5 | 5 | 5 | 5 | 5 |
| | containing | | | | | | | | |
| | compound | | | | | | | | |
| | HALS | HALS1 | | | | | | | |
| | | HALS2 | | 0.5 | 0.5 | 0.5 | 0.5 | 0.5 | 0.5 |
| | Calcium carbonate | | | | 5 | 10 | 40 | 100 | 120 |
| Characteristics | Mechanical | Tensile | | 19.4 | 18.9 | 18.6 | 15.6 | 10.7 | 9.6 |
| | characteristics | strength (MPa) | | | | | | | |
| | Flame | Vertical | Pass | 0 | 40 | 100 | 100 | 100 | 100 |
| | retardancy | flame | rate | | | | | | |
| | | test | (%) | | | | | | |

TABLE 24

| | | | | Comparative | Comparative | Example | Example | Example | Example |
|---|---|---|---|---|---|---|---|---|---|
| | | | | Example 51 | Example 52 | 83 | 77 | 84 | 85 |
| Composition | Polyolefin resin | PE | | 97 | 97 | 97 | 97 | 97 | 97 |
| | Silicone MB | Silicone MB | | 3/3 | 3/3 | 3/3 | 3/3 | 3/3 | 3/3 |
| | | (PE/Silicone | | | | | | | |
| | | gum) | | | | | | | |
| | Fatty acid | Mg stearate | | | 2 | 3 | 5 | 10 | 20 |
| | containing | | | | | | | | |
| | compound | | | | | | | | |
| | HALS | HALS1 | | | | | | | |
| | | HALS2 | | 0.5 | 0.5 | 0.5 | 0.5 | 0.5 | 0.5 |
| | Calcium carbonate | | | 40 | 40 | 40 | 40 | 40 | 40 |
| Characteristics | Mechanical | Tensile strength | | 16.6 | 16.1 | 16.0 | 15.6 | 15.1 | 14.4 |
| | characteristics | (MPa) | | | | | | | |
| | Flame retardancy | Vertical | Pass | 0 | 0 | 100 | 100 | 100 | 100 |
| | | flame | rate | | | | | | |
| | | test | (%) | | | | | | |

TABLE 25

| | | | | Comparative | Comparative | Example | Example | Example | Example |
|---|---|---|---|---|---|---|---|---|---|
| | | | | Example 53 | Example 54 | 86 | 77 | 87 | 88 |
| Composition | Polyolefin resin | PE | | 100 | 99.5 | 98.5 | 97 | 95 | 90 |
| | Silicone MB | Silicone MB | | | 0.5/0.5 | 1.5/1.5 | 3/3 | 5/5 | 10/10 |
| | | (PE/Silicone | | | | | | | |
| | | gum) | | | | | | | |
| | Fatty acid | Mg stearate | | 5 | 5 | 5 | 5 | 5 | 5 |
| | containing | | | | | | | | |
| | compound | | | | | | | | |
| | HALS | HALS1 | | | | | | | |
| | | HALS2 | | 0.5 | 0.5 | 0.5 | 0.5 | 0.5 | 0.5 |
| | Calcium carbonate | | | 40 | 40 | 40 | 40 | 40 | 40 |
| Characteristics | Mechanical | Tensile strength | | 15.8 | 15.6 | 15.9 | 15.6 | 15.0 | 14.0 |
| | characteristics | (MPa) | | | | | | | |
| | Flame retardancy | Vertical | Pass | 0 | 0 | 100 | 100 | 100 | 100 |
| | | flame | rate | | | | | | |
| | | test | (%) | | | | | | |

For the insulating wires of Examples 1 to 88 and Comparative Examples 1 to 54 which have been obtained as described above, evaluations regarding flame retardancy and mechanical characteristics were made as follows.

<Flame Retardancy>

For 10 insulating wires which have been obtained from each of Examples 1 to 88 and Comparative Examples 1 to 54, a vertical combustion test for a single wire was carried out based on JIS C3665-1. In addition, ratio of the insulating wires which satisfy all the requirements of the following (1A) and (2A) among the 10 insulating wires was set as pass rate (unit: %) and calculated based on the following formula (3A). The results are shown in Tables 1 to 25. Furthermore, in Tables 1 to 25, the criteria for determining the pass or failure in terms of flame retardancy were as described below.
(1A) The distance between the bottom end of a top support member supporting the insulating wire from the top and the start point of inflammation is 50 mm or more, and combustion of the insulating wire was not spread over 540 mm or lower from the bottom end of the top support member.
(2A) Time from flame removal to self-extinguishment is 60 seconds or less.

Pass rate (%)=100×Number of insulating wires satisfying both the above criteria (1A) and (A2)/Total number of insulating wires subjected to test (10 pieces) (3A)

Pass: pass rate of 80% or higher

Failure: pass rate of lower than 80%

<Mechanical Characteristics>

Evaluation of the mechanical characteristics was made based on the tensile strength which was measured by performing the elongation test according to JIS C3005 for the insulating wires of Examples 1 to 88 and Comparative Examples 1 to 54. The results are shown in Tables 1 to 25. In Tables 1 to 25, unit of the tensile strength is MPa, and the criteria for determining the pass or failure in terms of tensile strength were as described below. Furthermore, in the tensile test, the elongation speed was 200 mm/min and the gauge length was 20 mm.

10 MPa or higher: pass

Lower than 10 MPa: failure

From the results of Tables 1 to 25, the flame retardant resin compositions of Examples 1 to 88 satisfied the pass criteria regarding the flame retardancy and mechanical characteristics. In contrast, the flame retardant resin compositions of Comparative Examples 1 to 54 did not satisfy the pass criteria regarding at least one of the flame retardancy and mechanical characteristics.

From the above, it was confirmed that excellent mechanical characteristics and also excellent flame retardancy can be secured according to the flame retardant resin composition of one or more embodiments of the present invention.

### EXPLANATIONS OF REFERENCE NUMERALS

1 . . . Internal conductor
2 . . . Insulating body
3 . . . Outer sheath (insulating body)
4 . . . Insulating wire
10 . . . Round cable (cable)
20 . . . Optical fiber cable
24 . . . Optical fiber
25 . . . Outer sheath (insulating body)

Although the disclosure has been described with respect to only a limited number of embodiments, those skilled in the art, having benefit of this disclosure, will appreciate that various other embodiments may be devised without departing from the scope of the present invention. Accordingly, the scope of the invention should be limited only by the attached claims.

1. A flame retardant resin composition comprising:
a polyolefin resin;
a silicone compound;
a fatty acid containing compound;
calcium carbonate; and
a triazine ring containing hindered amine compound, wherein
the silicone compound is blended at a ratio of 1.5 parts by mass or more and 10 parts by mass or less relative to 100 parts by mass of the polyolefin resin, the fatty acid containing compound is blended at a ratio of 3 parts by mass or more and 20 parts by mass or less relative to 100 parts by mass of the polyolefin resin,
the calcium carbonate is blended at a ratio of 10 parts by mass or more and less than 120 parts by mass relative to 100 parts by mass of the polyolefin resin, the triazine ring containing hindered amine compound is blended at a ratio of 0.05 part by mass or more and less than 10 parts by mass relative to 100 parts by mass of the polyolefin resin, and
the triazine ring containing hindered amine compound includes an oxygen atom.

2. The flame retardant resin composition according to claim 1, wherein the triazine ring containing hindered amine compound is blended at a ratio of 0.1 part by mass or more and less than 10 parts by mass relative to 100 parts by mass of the polyolefin resin.

3. The flame retardant resin composition according to claim 1, wherein the triazine ring containing hindered amine compound has a group represented by the following formula (1): 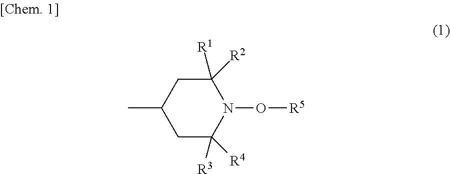
(in the above formula (1), R¹ to R⁴ are each independently an alkyl group having 1 to 8 carbon atoms, R⁵ is an alkyl group having 1 to 18 carbon atoms, a cycloalkyl group having 5 to 12 carbon atoms, an aralkyl group having 7 to 25 carbon atoms, or an aryl group having 6 to 12 carbon atoms).

4. The flame retardant resin composition according to claim 3, wherein, in the formula (1), R¹ to R⁴ each independently represent an alkyl group having 1 to 3 carbon atoms and R⁵ represents a cyclolalkyl group.

5. The flame retardant resin composition according to claim 3, wherein the triazine ring containing hindered amine compound is represented by the following formula (2): 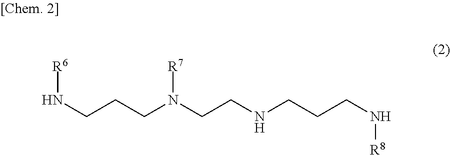
(in the above formula (2), R⁶ to R⁸ each independently represent a group represented by the following formula (3)). 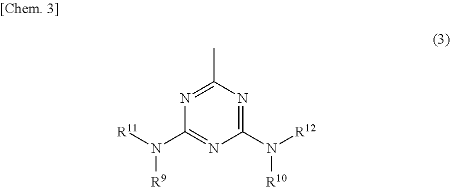
(in the above formula (3), R⁹ and R¹⁰ each independently represent a group represented by the above formula (1), and R¹¹ and R¹² each independently represent an alkyl group having 1 to 18 carbon atoms).

6. The flame retardant resin composition according to claim 5, wherein the triazine ring containing hindered amine compound is constituted by a compound which is represented by the formula (2), and in which R¹ to R⁴ each independently represent an alkyl group having 1 to 3 carbon atoms and R⁵ represents a cycloalkyl group having 5 to 8 carbon atoms in the formula (1), and R¹¹ and R¹² represent an alkyl group having 1 to 6 carbon atoms in the above formula (3).

7. The flame retardant resin composition according to claim 1,
wherein the silicone compound is blended at a ratio of 1.5 parts by mass or more and less than 5 parts by mass relative to 100 parts by mass of the polyolefin resin,
the fatty acid containing compound is blended at a ratio of 3 parts by mass or more and less than 5 parts by mass relative to 100 parts by mass of the polyolefin resin, and
the calcium carbonate is blended at a ratio of 10 parts by mass or more and 40 parts by mass or less relative to 100 parts by mass of the polyolefin resin.

8. The flame retardant resin composition according to claim 1, wherein the polyolefin resin is constituted by at least one kind selected from the group consisting of polyethylene, acid modified polyethylene, an ethylene-vinyl acetate copolymer, an ethylene-ethyl acrylate copolymer, and polypropylene.

9. A cable comprising:
a conductor; and
at least one insulating body covering the conductor,
wherein the insulating body is constituted by the flame retardant resin composition according to claim 1.

10. An optical fiber cable comprising:
an optical fiber; and
an insulating body covering the optical fiber,
wherein the insulating body is constituted by the flame retardant resin composition according to claim 1.
